(19) United States
(12) Patent Application Publication
(10) Pub. No.: US 2006/0072835 A1
(43) Pub. Date: Apr. 6, 2006

(54) Image pickup device and decoding device

(76) Inventors: Yiwen Zhu, Kanagawa (JP); Kazushi Sato, Kanagawa (JP); Yoichi Yagasaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/237,943

(22) Filed: Sep. 29, 2005

(30) Foreign Application Priority Data
Oct. 1, 2004 (JP) 2004-290288

(51) Int. Cl. G06K 9/36

(52) U.S. Cl. 382/232

(57) ABSTRACT

An image pickup device includes an image pickup unit outputting an image pickup result; an analog-to-digital converter analog-to-digital converting the image pickup result and outputting image data; a reduced image generator generating a plurality of reduced images by sequentially and gradually reducing a resolution of an original image based on the image data a number of times equal to a predetermined number of stages; an encoder in which, for a reduced image with the lowest resolution, corresponding image data is encoded and encoded data is output, and for the other reduced images and the original image, differential data with respect to prediction image data based on the reduced image with a resolution lower by one stage is encoded and encoded data is output; and a prediction image data generator generating the prediction image data from the encoded data.

### CROSS REFERENCES TO RELATED APPLICATIONS

The present invention contains subject matter related to Japanese Patent Application JP 2004-290288 filed in the Japanese Patent Office on Oct. 1, 2004, the entire contents of which are incorporated herein by reference.

### BACKGROUND OF THE INVENTION

1. Field of the Invention

The present invention relates to image pickup devices and decoding devices, and is applicable to, for example, monitoring apparatuses.

2. Description of the Related Art

Recently, for transmission and recording of moving images in broadcasting stations, homes, and the like, apparatuses for efficiently transmitting and accumulating image data by effectively using redundancy of the image data have become commonplace. Such apparatuses compress image data by orthogonal transform, such as discrete cosine transform (DCT), and motion compensation in accordance with, for example, Moving Picture Experts Group (MPEG) methods or the like.

MPEG2 (defined by International Organization for Standardization/International Electrotechnical Commission (ISO/IEC) 13818-2), which is one type of such methods, is defined as a general-purpose image encoding method. MPEG2 is also defined as being able to deal with both interlaced scanning and sequential scanning and being able to deal with both standard-resolution images and high-resolution images. Thus, MPEG2 has been used for a wide range of applications for professional use and consumer use. More specifically, according to MPEG2, a high data compression ratio with high image quality can be ensured by, for example, compressing image data with a standard resolution of 720×480 pixels in an interlaced scanning format into a bit rate of 4 to 8 Mbps or, for example, compressing image data with a high resolution of 1920×1088 pixels in an interlaced scanning format into a bit rate of 18 to 22 Mbps.

However, MPEG2 is a high image quality encoding method suitable for broadcasting and does not deal with encoding for a high compression ratio with a code amount smaller than MPEG1. Since portable terminals have been widely used in recent years, an increased requirement for encoding methods for a high compression ratio with a code amount smaller than MPEG1 is estimated. Thus, an MPEG4 encoding standard was internationally agreed as an international standard by ISO/IEC 14496-2 in December 1998.

In addition, as such encoding methods, standardization of H.26L (ITU-T Q6/16 VCEG), which was initially aimed at image encoding for television conferences, has progressed. Although H.26L requires a larger amount of computation compared with MPEG2 and MPEG4, H.26L ensures a higher encoding efficiency compared with MPEG2 and MPEG4. In addition, as a part of activities of MPEG4, standardization of an H.26L-based encoding method that realizes various functions and that ensures a much higher encoding efficiency has progressed as “Joint Model of Enhanced-Compression Video Coding”. Such methods were set as an international standard by the name of H.264/MPEG-4 Part10 Advanced Video Coding (AVC) in March 2003.

FIG. 4 is a block diagram showing an encoding device 1 based on the AVC technology. The encoding device 1 selects an optimal prediction mode from among a plurality of intra prediction modes or a plurality of inter prediction modes, generates differential data by subtracting a prediction value based on the selected prediction mode from image data, and performs orthogonal transform, quantization, and variable-length encoding on the differential data. Accordingly, the encoding device 1 encodes the image data by intra-encoding or inter-encoding.

In other words, in the encoding device 1, an analog-to-digital converter circuit (A/D) 2 analog-to-digital converts a video signal SV, and outputs image data D1. A screen rearrangement buffer 3 receives the image data D1 output from the analog-to-digital converter circuit 2, rearranges frames of the image data D1 in accordance with a group of pictures (GOP) structure based on encoding processing of the encoding device 1, and outputs the processed image data D1.

A subtractor 4 receives the image data D1 output from the screen rearrangement buffer 3. For intra-encoding, the subtractor 4 generates differential data D2 with respect to a prediction value generated by an intra prediction circuit 5 and outputs the generated differential data D2. For inter-encoding, the subtractor 4 generates differential data D2 with respect to a prediction value generated by a motion prediction and compensation circuit 6 and outputs the generated differential data D2. An orthogonal transform circuit 7 receives the differential data D2 output from the subtractor 4, performs orthogonal transform, such as DCT or Karhunen-Loeve transform, and outputs transform coefficient data D3 as a processing result.

A quantization circuit 8 quantizes the transform coefficient data D3 in accordance with a quantization scale under the rate control of a rate control circuit 9, and outputs the quantized data. A lossless encoding circuit 10 performs lossless encoding, such as variable-length encoding or arithmetic encoding, on the data output from the quantization circuit 8. In addition, the lossless encoding circuit 10 acquires information on an intra prediction mode for intra-encoding and information on a motion vector for inter-encoding from the intra prediction circuit 5 and the motion prediction and compensation circuit 6, respectively. The lossless encoding circuit 10 sets the acquired information as header information of encoded data D4, and outputs the encoded data D4.

An accumulation buffer 11 accumulates the encoded data D4 output from the lossless encoding circuit 10, and outputs the encoded data D4 at a transmission speed of a subsequent transmission channel. The rate control circuit 9 monitors the amount of code generated due to encoding by monitoring the free space of the accumulation buffer 11, and at the same time, switches the quantization scale in the quantization circuit 8 in accordance with the monitoring result. Accordingly, the rate control circuit 9 controls the amount of code generated by the encoding device 1.

A dequantization circuit 13 dequantizes the data output from the quantization circuit 8 to reproduce the data input to the quantization circuit 8. An inverse-orthogonal transform circuit 14 performs inverse-orthogonal transform on the data output from the dequantization circuit 13 to reproduce the data input to the orthogonal transform circuit 7. A block noise eliminating filter 15 eliminates block noise from the data output from the inverse-orthogonal transform circuit 14, and outputs data not including block noise. A frame memory 16 adds a prediction value generated by the intra prediction circuit 5 or the motion prediction and compensation circuit 6 to the data output from the block noise eliminating filter 15 according to need, and records the acquired data as reference image information.

Accordingly, the motion prediction and compensation circuit 6 detects a motion vector of the image data output from the screen rearrangement buffer 3 in accordance with a prediction frame (reference frame) based on the reference image information stored in the frame memory 16, and detects an optimal mode for inter prediction by performing motion compensation on the reference image information stored in the frame memory 16 using the detected motion vector. In addition, when encoding is performed based on inter prediction, prediction image information is generated based on the optimal mode, and a prediction value based on the prediction image information is output to the subtractor 4.

For intra-encoding, the intra prediction circuit 5 detects an optimal mode of an intra prediction mode in accordance with the reference image information accumulated in the frame memory 16. In addition, when encoding is performed based on intra prediction, a prediction value of prediction image information is generated from the reference image information based on the optimal mode and output to the subtractor 4.

Accordingly, in such an encoding method, differential data D2 based on motion compensation for inter prediction and differential data D2 based on intra prediction are generated by inter-encoding and intra-encoding, respectively. The differential data D2 are subjected to, orthogonal transform, quantization, and variable-length encoding, and the processed data is transmitted.

FIG. 5 is a block diagram showing a decoding device 20 for decoding the encoded data D4. In the decoding device 20, an accumulation buffer 21 temporarily accumulates and outputs the encoded data D4 input via the transmission channel. A lossless decoding circuit 22 decodes the data output from the accumulation buffer 21 by variable-length decoding, arithmetic decoding, or the like, and reproduces the data input to the lossless encoding circuit 10 of the encoding device 1. If the data output from the accumulation buffer 21 is data obtained by intra-encoding, the information on the intra prediction mode stored in the header is decoded and transmitted to an intra prediction circuit 23. If the data output from the accumulation buffer 21 is data obtained by inter-encoding, the information on the motion vector stored in the header is decoded and transmitted to a motion prediction and compensation circuit 24.

A dequantization circuit 25 performs dequantization on the data output from the lossless decoding circuit 22, and reproduces the transform coefficient data D3 input to the quantization circuit 8 of the encoding device 1. An inverse-orthogonal transform circuit 26 receives the transform coefficient data output from the dequantization circuit 25, and performs quaternary inverse-orthogonal transform to reproduce the differential data D2 input to the orthogonal transform circuit 7 of the encoding device 1.

An adder 27 receives the differential data D2 output from the inverse-orthogonal transform circuit 26. For intra-encoding, the adder 27 adds a prediction value based on a prediction image generated by the intra prediction circuit 23, and outputs the acquired data. For inter-encoding, the adder 27 adds a prediction value based on a prediction image output from the motion prediction and compensation circuit 24, and outputs the acquired data. Accordingly, the adder 27 reproduces the data input to the subtractor 4 of the encoding device 1.

A block noise eliminating filter 28 eliminates block noise from the data output from the adder 27, and outputs data not including block noise. A screen rearrangement buffer 29 rearranges frames of the image data output from the block noise eliminating filter 28 in accordance with the GOP structure. A digital-to-analog converter circuit (D/A) 30 digital-to-analog converts the data output from the screen rearrangement buffer 29, and outputs the converted data.

A frame memory 31 records and stores the data output from the block noise eliminating filter 28 as reference image information. For inter-encoding, the motion prediction and compensation circuit 24 generates a prediction value based on a prediction image by performing motion compensation on the reference image information stored in the frame memory 31 in accordance with information on the motion vector reported from the lossless decoding circuit 22, and outputs the generated prediction value to the adder 27. For intra-encoding, the intra prediction circuit 23 generates a prediction value based on a prediction image from the reference image information stored in the frame memory 31 in accordance with the intra prediction mode reported from the lossless decoding circuit 22, and outputs the generated prediction value to the adder 27.

DCT according to such a series of processing is represented by condition (1). Here, “Nx” and “Ny” represent the numbers of pixels of a block for DCT in the horizontal and vertical directions, respectively.

$$F ( u , v ) = \frac{2 c ( u ) c ( v )}{\sqrt{{N}_{x} {N}_{y}}} {\sum }_{x = 0}^{{N}_{x - 1}} {\sum }_{y = 0}^{{N}_{y - 1}} f ( x , y ) cos \{ \frac{( 2 x + 1 ) u}{2 {N}_{x}} π \} cos \{ \frac{( 2 y + 1 )}{2 {N}_{y}} π \} \\ where \\ c ( u ) c ( v ) = \{ \begin{matrix}1 / \sqrt{2} … u , v = 0 \\ 1 … u = 1 , 2 , 3 , … , {N}_{x - 1} ; v = 1 , 2 , 3 , … , {N}_{y - 1}\end{matrix} \qquad ( 1 )$$

In such intra-encoding, adaptive differential pulse code modulation (ADPCM) is performed by encoding a differential value with respect to a prediction value. Prediction values are generated in accordance with seven types of modes, as shown in FIG. 6 and condition (2). For easier understanding of modes, generation of prediction values is schematically explained based on the relationship with adjacent pixels using FIG. 6 and condition (2). In the actual AVC technology, prediction values are generated in accordance with adjacent pixels of a block formed by 4×4 pixels or 16×16 pixels.
Px=a
Px=b
Px=c
Px=a+b−c
Px=a+(b−c)/2
Px=b+(a−c)/2
Px=(a+b)/2 (2)

Here, “x” represents a pixel to be processed. In a first mode, a pixel value of an adjacent pixel “a” on a raster scanning start side in the horizontal direction is set as a prediction value. In a second mode, a pixel value of an adjacent pixel “b” on the raster scanning start side in the vertical direction of the adjacent pixel “a” is set as a prediction value. In a third mode, a pixel value of an adjacent pixel “c” next to the adjacent pixel “b” is set as a prediction value. In fourth to seventh modes, pixel values are set by arithmetic processing of the pixel values of the pixels “a” to “c”.

Accordingly, the encoding device 1 transmits a prediction error E obtained by arithmetic processing based on condition (3) using the prediction values and modes used for generating the prediction error E. The decoding device 20 generates prediction values as in the encoding device 1 in accordance with the transmitted information, and decodes original data.
E=x−Px
x=E+Px (3)

Such an encoding device is used, for example, for data compression of an image pickup result of an image pickup element. Recently, complementary metal-oxide semiconductor (CMOS) solid-state image pickup elements have been widely used compared with known charge-coupled device (CCD) solid-state image pickup elements.

As shown in FIG. 7, in a CCD solid-state image pickup element 41, accumulated charges stored in pixels 42 each including a photodiode are transferred to vertical transfer registers 43, and the accumulated charges transferred to the vertical transfer registers 43 are sequentially transferred to a horizontal transfer register 44 and sequentially output from the horizontal transfer register 44. Accordingly, normally, the CCD solid-state image pickup element 41 outputs image pickup results in accordance with the order of raster scanning. In contrast, as shown in FIG. 8, a CMOS solid-state image pickup element 46 outputs accumulated charges stored in pixels 49 each including a photodiode under XY address control by a vertical scanning circuit 47 and a horizontal scanning circuit 48. Thus, the CMOS solid-state image pickup element 46 is capable of reading image pickup results of the pixels 49 at a high speed, and high flexibility is ensured even in a reading order or the like. In addition, the CMOS solid-state image pickup element 46 requires less power consumption, which is about one-fifth of the power consumption of the CCD solid-state image pickup element. In addition, the CMOS solid-state image pickup element 46 can be easily integrated with peripheral circuitry.

FIG. 9 is a block diagram showing a processing system of the CCD solid-state image pickup element 41. In the CCD solid-state image pickup element 41, accumulated charges, which are image pickup results of the pixels 42, are sequentially transferred and input to a floating diffusion amplifier (FDA) 51 via the vertical registers (V registers) 43 and the horizontal register (H register) 44, and output voltages corresponding to the amount of accumulated charges are generated. In the processing system of the CCD solid-state image pickup element 41, a correlated double sampling circuit (CDS) 52 performs correlated double sampling on output signals of the floating diffusion amplifier 51. Then, a programmable gain amplifier (PGA) 53 corrects the signal level, and an analog-to-digital converter circuit (ADC) 54 converts the signals into image data.

FIG. 10 is a block diagram showing a processing system of the CMOS solid-state image pickup element 46. In the CMOS solid-state image pickup element 46, accumulated charges stored in the pixels 49 are converted into output voltages by floating diffusion amplifiers (FDAs) 56 provided in the respective pixels 49, and the output voltages are subjected to correlated double sampling for each row by a column CDS block (column CDS) 57 and output. In the processing system of the CMOS solid-state image pickup element 46, a programmable gate array (PGA) 58 processes the output signals of the column CDS block 57, and then, an analog-to-digital converter circuit (ADC) 59 converts the signals into image data.

FIG. 11 is a block diagram showing a specific system structure of the CCD solid-state image pickup element 41. In the CCD solid-state image pickup element 41, a driving circuit 64 including a timing generator (TG) 61 for generating various timing signals functioning as operation standards and a vertical driving circuit 62 and a horizontal driving circuit 63 for generating various driving signals used for driving the CCD solid-state image pickup element 41 from the timing signals generated by the timing generator 61 is arranged as one chip. In addition, an analog front end (AFE) 65 including the correlated double sampling circuit (CDS) 52, the programmable gain amplifier (PGA) 53, and the analog-to-digital converter circuit (ADC) 54 is arranged as one chip, and image data output from the analog front end 65 is processed by a digital signal processor (DSP) 66. Normally, the driving circuit 64 and the analog front end 65 are integrated with each other into one package. Accordingly, normally, the system of the CCD solid-state image pickup element 41 is formed by four chips integrated into three packages. The driving circuit 64 and the analog front end 65 may be integrated with each other based on a technology for stacking two into a single package.

FIG. 12 is a block diagram showing a specific system structure of the CMOS solid-state image pickup element 46. In the CMOS solid-state image pickup element 46, the pixels 49 arranged in a matrix form a pixel unit 67. A control logic 68 controls operations of the vertical scanning circuit 47, the horizontal scanning circuit 48, the column CDS block 57, the programmable gate array 58, and the analog-to-digital converter circuit 59. These circuit blocks are integrated with each other as an integrated circuit. In addition, a digital signal processor (DSP) 69 processes image data output from the integrated circuit. Accordingly, in the example shown in FIG. 12, the CMOS solid-state image pickup element 46 is formed by two chips. The system of the CMOS solid-state image pickup element 46 may be formed by three chips by forming another chip by the programmable gate array 58 and the analog-to-digital converter circuit 59.

With respect to transmission of image data by such an encoding device, for example, a method for changing the amount of data for transmission of image data by changing the amount of pixel skipping in accordance with a bandwidth of a transmission channel is suggested, for example, in International Publication No. WO00/04716.

In recent years, the Internet has been used for transmission of various data as well as browsing of homepages. Thus, by encoding video signals output from an image pickup device for monitoring and transmitting image data as a processing result via the Internet, for example, a user is able to check the condition of the user's home from a remote place or check the site of construction or accident from a distant place.

However, a terminal device used for such checking may be a computer or a cellular phone. In addition, such a terminal device may be connected to the Internet using an optical fiber line or a cellular phone line. Thus, it is desirable for an encoding device applied to such a monitoring device to have a bandwidth of a transmission channel that changes in a wide range and to properly deal with such a change in the bandwidth.

### SUMMARY OF THE INVENTION

It is desirable to properly deal with a change in a bandwidth of a transmission channel even when the bandwidth of the transmission channel changes in a wide range.

An image pickup device according to an embodiment of the present invention includes an image pickup unit outputting an image pickup result; an analog-to-digital converter analog-to-digital converting the image pickup result and outputting image data; a reduced image generator generating a plurality of reduced images by sequentially and gradually reducing a resolution of an original image based on the image data a number of times equal to a predetermined number of stages; an encoder in which, for a reduced image with the lowest resolution from among the plurality of reduced images generated by the reduced image generator, corresponding image data is encoded and encoded data is output, and for the other reduced images and the original image, differential data with respect to prediction image data based on the reduced image with a resolution lower by one stage is encoded and encoded data is output; and a prediction image data generator generating the prediction image data from the encoded data.

With this structure, an output stage for encoding can be changed in accordance with an object to be transmitted or the like. Thus, even when the bandwidth of a transmission channel changes in a wide range, the change in the bandwidth can be properly dealt with.

In a decoding device according to an embodiment of the present invention for decoding image data encoded by a predetermined encoding device, the encoding device includes a reduced image generator generating a plurality of reduced images by sequentially and gradually reducing a resolution of an original image based on the image data a number of times equal to a predetermined number of stages, an encoder in which, for a reduced image with the lowest resolution from among the plurality of reduced images generated by the reduced image generator, corresponding image data is encoded and encoded data is output, and for the other reduced images and the original image, differential data with respect to prediction image data based on the reduced image with a resolution lower by one stage is encoded and encoded data is output, and a prediction image data generator generating the prediction image data from the encoded data; and the decoding device includes a decoder decoding the encoded data to output the image data and the differential data, an image memory temporarily storing the image data acquired by the decoder, an enlarged image generator generating the prediction image data by increasing by one stage the resolution of the image data stored in the image memory, and an adding circuit generating image data by adding the differential data decoded by the decoder to the prediction image data and updating the image data recorded in the image memory using the generated image data.

With this structure, even when the bandwidth of the transmission channel changes in a wide range, the change in the bandwidth can be properly dealt with.

As described above, a plurality of reduced images is generated by sequentially and gradually reducing resolution. For a reduced image with the lowest resolution, image data is encoded and output. For the other reduced images and the original image, differential data with respect to prediction image data based on a reduced image with a resolution lower by one stage is encoded and output. Accordingly, by changing the number of stages in accordance with the bandwidth usable for transmission, even if the bandwidth of a transmission channel changes in a wide range, the change in the bandwidth can be properly dealt with.

### BRIEF DESCRIPTION OF THE DRAWINGS

FIG. 1 is a block diagram showing an encoding unit of a monitoring device according to an embodiment of the present invention;

FIG. 2 is a block diagram showing a monitoring system according to the embodiment of the present invention;

FIG. 3 is a block diagram showing a decoding unit of a terminal device in the monitoring system shown in FIG. 2;

FIG. 4 is a block diagram showing an encoding device based on AVC technology;

FIG. 5 is a block diagram showing a decoding device based on the AVC technology;

FIG. 6 is a schematic diagram for explaining a prediction mode;

FIG. 7 is a schematic diagram showing a CCD solid-state image pickup element;

FIG. 8 is a schematic diagram showing a CMOS solid-state image pickup element;

FIG. 9 is a block diagram showing a processing system of the CCD solid-state image pickup element;

FIG. 10 is a block diagram showing a processing system of the CMOS solid-state image pickup element;

FIG. 11 is a block diagram showing the system structure of the CCD solid-state image pickup element; and

FIG. 12 is a block diagram showing the system structure of the CMOS solid-state image pickup element.

### DESCRIPTION OF THE PREFERRED EMBODIMENTS

Embodiments of the present invention will now be described with reference to the drawings.

### First Embodiment

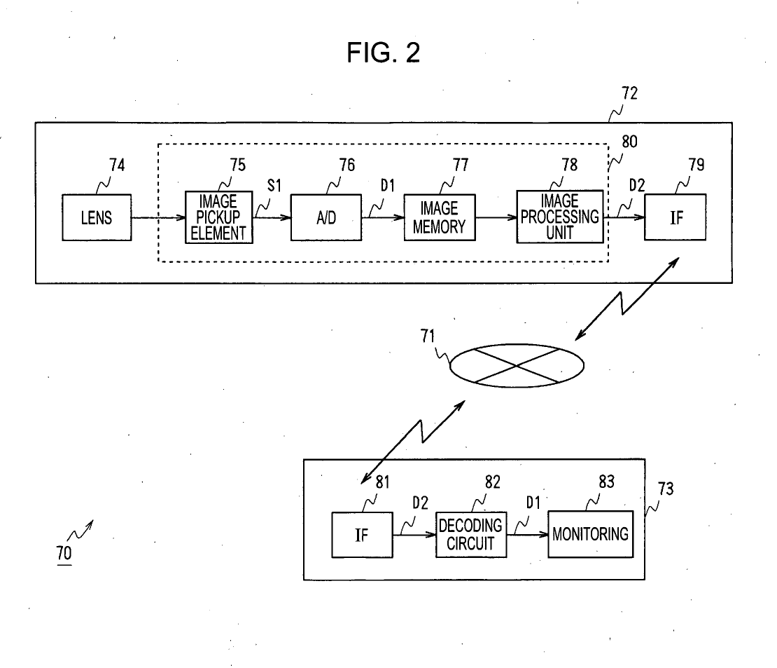

FIG. 2 is a block diagram showing a monitoring system 70 according to a first embodiment of the present invention. In the monitoring system 70, an image pickup result acquired by a monitoring device 72 is transmitted to a terminal device 73 via the Internet 71. The monitoring device 72 acquires the image pickup result by capturing an image in advance, performs data compression on the image pickup result, and sends the compressed image pickup result to the Internet 71. The terminal device 73 acquires the image pickup result acquired via the Internet 71, and displays the acquired image pickup result.

In the monitoring device 72, a lens 74 forms an image of an object on an image pickup face of an image pickup element 75 by collecting incident light to the image pickup face. The image pickup element 75 is, for example, a CMOS solid-state image pickup element. The image pickup element 75 operates in accordance with various timing signals output from a driving unit (not shown), photoelectrically converts the optical image formed on the image pickup face by pixels, and outputs an image pickup result. In this processing, the image pickup element 75 acquires the image pickup result at a frame rate corresponding to the data transfer speed of encoded data D2 output from an interface (I/F) 79 and outputs an image pickup signal S1 under the control of a control circuit 91, which will be described below, provided in an image processing circuit 78.

An analog-to-digital converter circuit (A/D) 76 analog-to-digital converts the image pickup signal S1, and outputs image data D1. An image memory 77 temporarily records and stores the image data D1 output from the analog-to-digital converter circuit 76, and sequentially outputs the image data D1 at timings corresponding to the subsequent processing of the image processing circuit 78.

The image processing circuit 78 encodes the image data D1 output from the image memory 77, and outputs encoded data D2 as a processing result. In this processing, the image processing circuit 78 switches the processing for the image data D1 in accordance with the data transfer speed of the subsequent interface 79. Accordingly, the monitoring device 72 sends the encoded data D2 based on a data transfer rate changing in a wide range in accordance with connection to the Internet 71 by the interface 79.

The interface 79 is a data communication unit including a plurality of connection sections for the Internet 71, and sends to the Internet 71 the encoded data D2 output from the image processing circuit 78. The connection sections are a wireless communication section used for connection by a cellular phone line, a wireless communication section used for connection by a wireless local-area network (LAN), a wired data communication section, and the like. Accordingly, in the monitoring device 72, in accordance with the connection to the Internet 71 via the interface 79, the data transfer rate for transmission of the encoded data D2 changes in a wide range, and processing for the encoded data D2 is switched in accordance with the change in the data transfer rate.

In the monitoring device 72 with such a structure, the image pickup element 75 is formed as an integrated circuit 80 by being integrated with peripheral circuitry by lamination of semiconductor chips. In the first embodiment, the peripheral circuitry relating to this integration includes the analog-to-digital converter circuit 76, the image memory 77, and the image processing circuit 78. Accordingly, the entire structure of an image pickup device according to the first embodiment is simplified.

In the terminal device 73, an interface (IF) 81 receives the encoded data D2 sent from the monitoring device 72 to the Internet 71, and outputs the received encoded data D2 to a decoding circuit 82. The decoding circuit 82 decodes the encoded data D2, and outputs the decoded image data. A monitor 83 displays an image based on the image data D2 output from the decoding circuit 82.

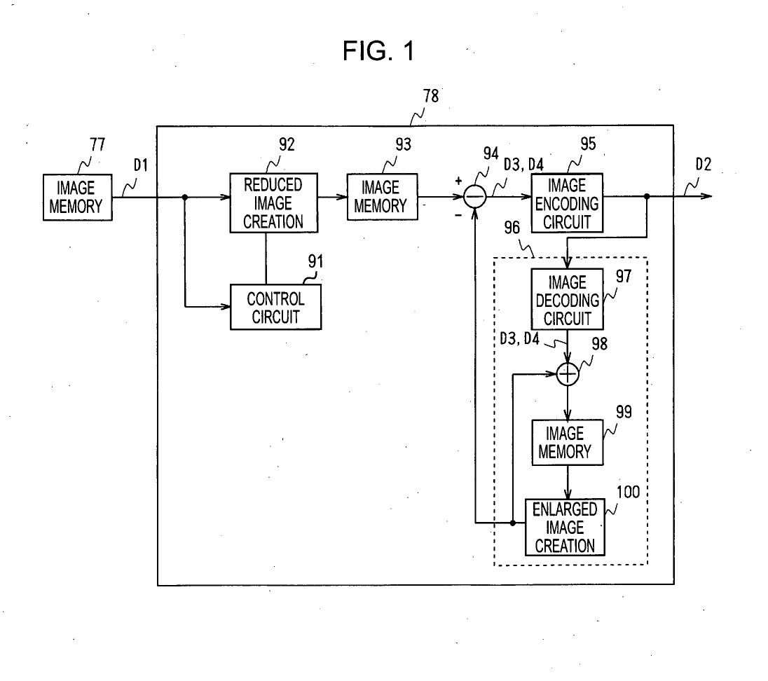

FIG. 1 is a block diagram showing the image processing circuit 78 of the monitoring device 72. The image processing circuit 78 generates a plurality of reduced images by sequentially and gradually reducing the resolution of the image data D1, sequentially encoding the reduced images in the order from a reduced image with the lowest resolution, and outputs the acquired encoded data D2. In addition, in accordance with a bandwidth of a transmission channel and the image data D1, the number of stages for reduction of resolution is changed, and the encoded data D2 is sequentially output in the order from a lower resolution.

In other words, in the image processing circuit 78, the control circuit 91 sets the number of stages so as to increase in accordance with a reduction in the data transfer rate of the encoded data D2 that can be output from the interface 79 in accordance with a connection section for connecting to the Internet 71, which is set in the interface 79 when the monitoring device 72 is installed. Accordingly, the image processing circuit 78 sets the number of stages in accordance with the bandwidth of a transmission channel limited by the interface 79. In addition, by detecting an activity by acquiring an image pickup result of the image data D1 stored in the image memory 77 in advance, difficulty in encoding is detected, and the amount of code generated by the encoding is predicted. The control circuit 91 sets the number of stages so as to increase in accordance with an increase in the predicted amount of generated code. Accordingly, the image processing circuit 78 sets the number of stages in accordance with the image data D1. After setting the number of stages as described above, the control circuit 91 instructs a reduced image creation circuit 92 and the like to reduce the resolution in accordance with the number of stages.

In addition, controlling operations of the reduced image creation circuit 92 and the like starts to output the encoded data D2. The data transfer speed is monitored in accordance with a response from the terminal device 73 detected by the interface 79. The frame rate by the image pickup element 75 is controlled in accordance with the monitoring result. Accordingly, in the first embodiment, when the bandwidth of the transmission channel is narrow, the frame rate is reduced by the amount corresponding to the bandwidth of the transmission channel, and an image pickup result is acquired. The acquired image pickup result is encoded and output.

The reduced image creation circuit 92 sequentially and gradually reduces the resolution of the image data D1 recorded in the image memory 77 under the control of the control circuit 91. In other words, the reduced image creation circuit 92 is a two-dimensional reduction filter. First, the reduced image creation circuit 92 outputs to an image memory 93 the image data D1 stored in the image memory 77 without any processing. Then, as processing in the first stage, the reduced image creation circuit 92 reduces the resolution of the image data D1 stored in the image memory 77 to half, and outputs the image data D1 with the reduced resolution. Accordingly, the reduced image creation circuit 92 generates a reduced image whose number of pixels is reduced to half in the horizontal and vertical directions with respect to the original image of the image data D1. Then, as processing in the second stage, the reduced image creation circuit 92 sets the image data of the reduced image with the reduced resolution as an object to be processed, and performs similar processing on the image data. Accordingly, the reduced image creation circuit 92 generates image data of a reduced image whose resolution is reduced to one-fourth in the horizontal and vertical directions with respect to the original image. The reduced image creation circuit 92 repeats processing of reducing resolution a number of times equal to the number of stages set by the control circuit 91 while changing an object to be processed.

The image memory 93 temporarily records and stores the image data output from the reduced image creation circuit 92, and outputs the image data in the order opposite to the order of stages output from the reduced image creation circuit 92. In other words, after outputting image data of a reduced image with the lowest resolution, the image memory 93 sequentially outputs image data in the order opposite to the order in which the resolution is gradually reduced in the reduced image creation unit 92.

A subtractor circuit 94 outputs to an image encoding circuit 95 the image data D3 of the reduced image with the lowest resolution without any processing. In the next stage, the subtractor circuit 94 acquires differential data D4 with respect to prediction image data output from a prediction image data generation circuit 96, and outputs the differential data D4 to the image encoding circuit 95.

The image encoding circuit 95 encodes the image data D3 and the differential data D4 output from the subtractor circuit 94, and outputs encoded data D2. Although an encoding circuit based on AVC, which is explained with reference to FIG. 4, is used as the image encoding circuit 95, an encoding circuit for lossless encoding or an encoding circuit for lossy encoding may be used as the image encoding circuit 95. Alternatively, an encoding circuit may be changed depending on the stage of data to be processed. In the first embodiment, as described below, by generating prediction image data by decoding image data encoded in advance, for example, a case where only a reduced image with the lowest resolution is subjected to lossless encoding to improve the image quality and a case where only differential data D4 for the original image is subjected to lossy encoding to improve the image quality are possible.

Accordingly, the prediction image data generation circuit 96 generates prediction image data for processing in the next stage from the encoded data D2 generated as described above. In other words, in the prediction image data generation circuit 96, an image decoding circuit 97 decodes the encoded data D2 to reproduce the image data D3 and the differential data D4 output from the subtractor circuit 94, and outputs the reproduced image data D3 and differential data D4. An adding circuit 98 receives the image data D3 and the differential data D4 output from the image decoding circuit 97. The adding circuit 98 outputs to an image memory 99 the image data D3 without any processing. In contrast, for the differential data D4, the adding circuit 98 generates image data of a corresponding reduced image by adding prediction image data output from an enlarged image creation circuit 100, and outputs the acquired image data to the image memory 99. Accordingly, image data in the immediately previous stage stored in the image memory 99 is sequentially updated by image data with a higher resolution.

The enlarged image creation circuit 100 increases the resolution of the reduced image based on the image data stored in the image memory 99 by one stage, and generates prediction image data for processing in the next stage.

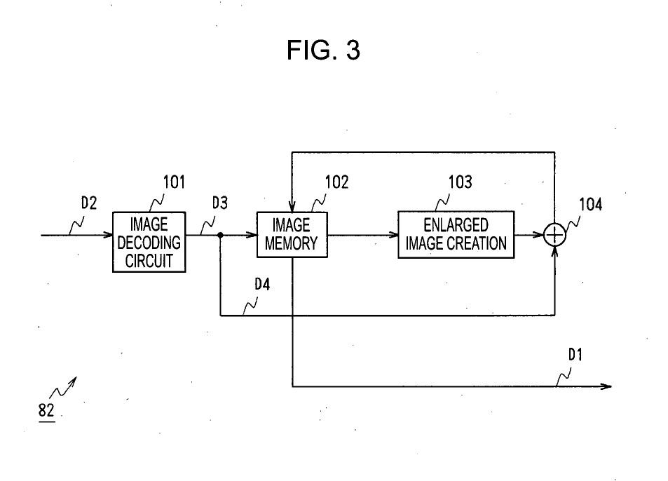

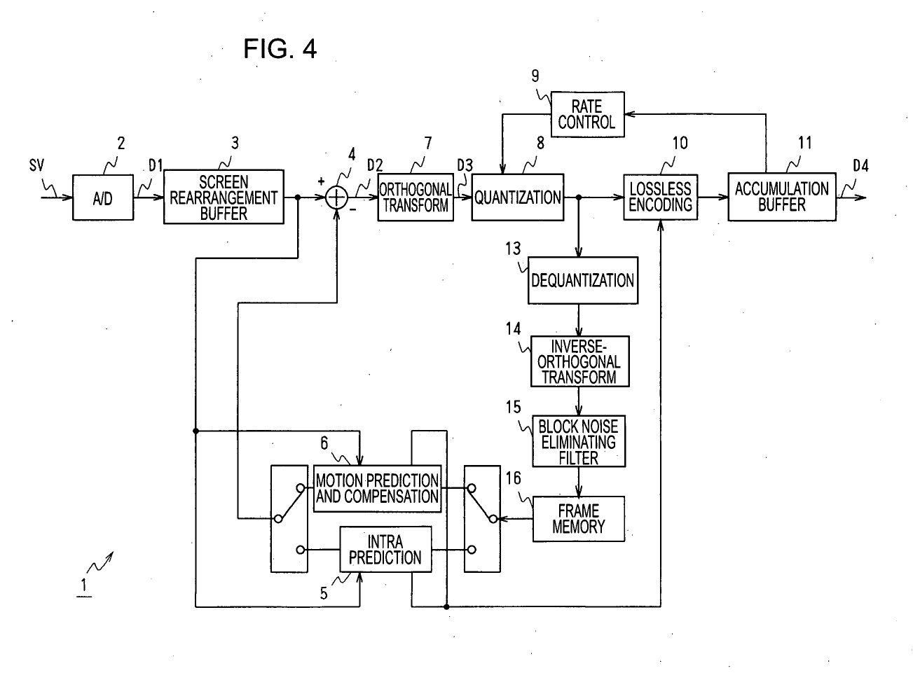

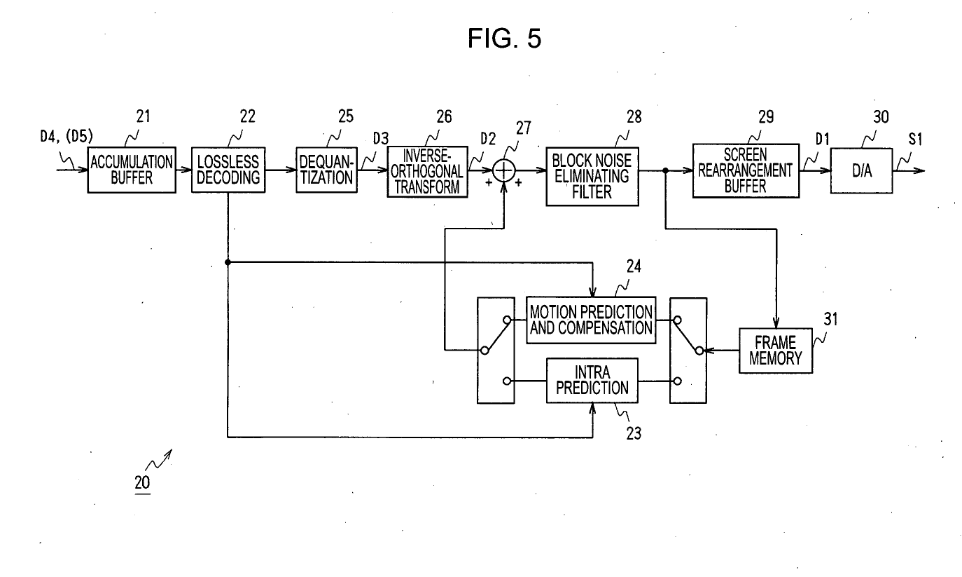

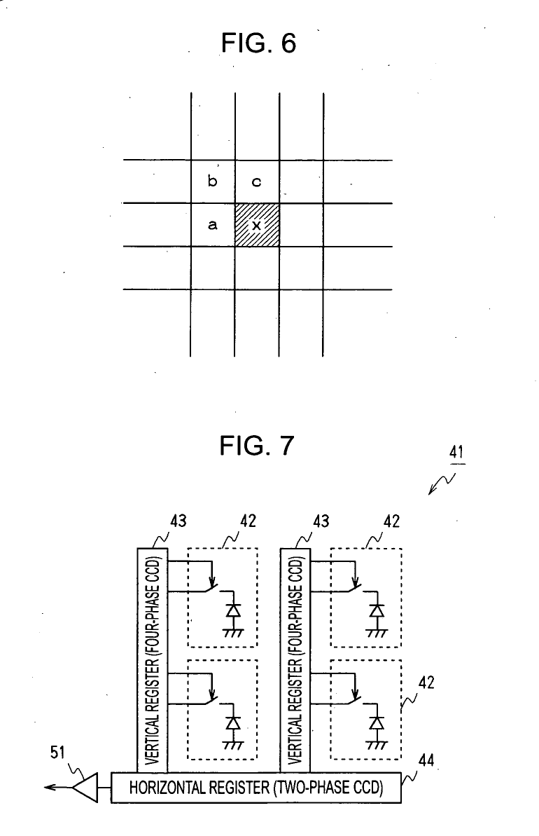

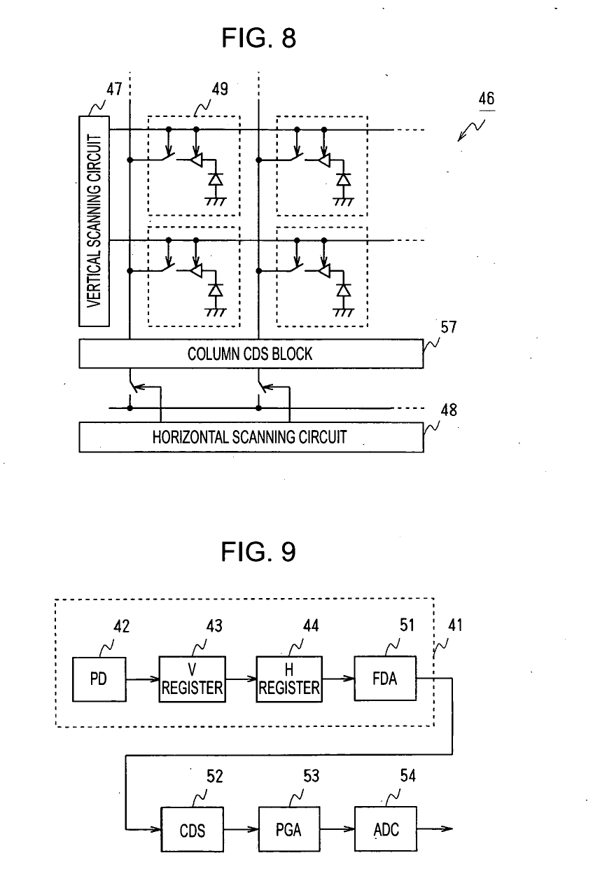

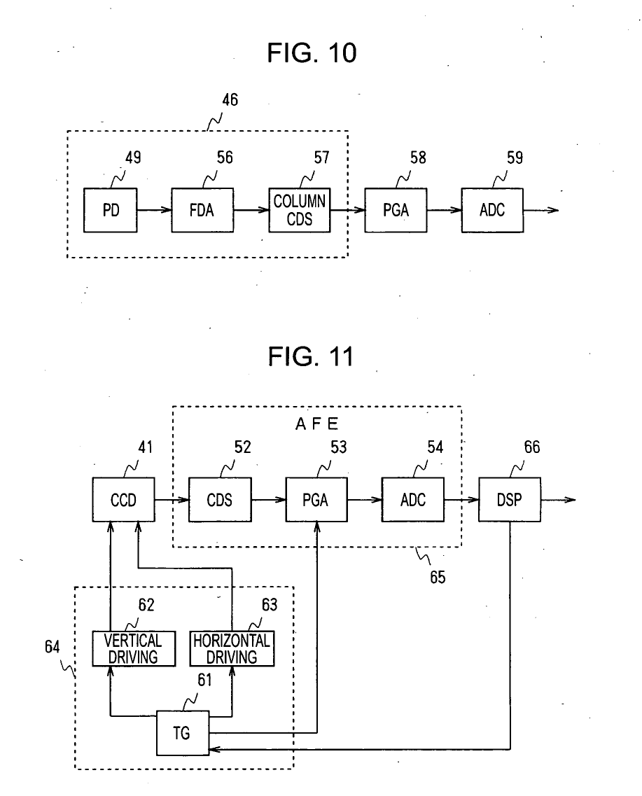

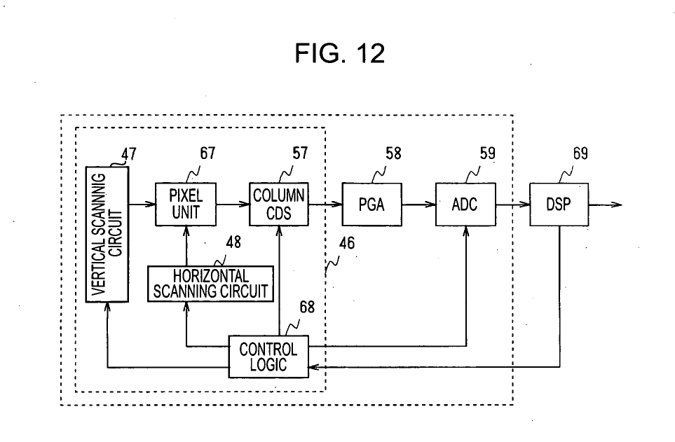

FIG. 3 is a block diagram showing the decoding circuit 82 provided in the terminal device 73. In the decoding circuit 82, an image decoding circuit 101 receives the encoded data D2 from the interface 81, acquires the image data D3 and the differential data D4 by decoding, and outputs the acquired image data D3 and differential data D4. An image memory 102 receives and temporarily stores the image data D3 output from the image decoding circuit 101, and updates the stored image data using image data received from an adding circuit 104.

An enlarged image creation circuit 103 increases the resolution of the reduced image based on the image data stored in the image memory 102 by one stage, generates prediction image data for processing in the next stage, and outputs the generated prediction image data. The adding circuit 104 generates image data of a corresponding reduced image and the original image by adding the prediction image data output from the enlarged image creation circuit 103 and the differential data D4 output from the image decoding circuit 101, and outputs the generated image data to the image memory 102.

With this structure, in the monitoring system 70 (see FIG. 2), image data acquired from the monitoring device 72 as a monitoring result is encoded and output as encoded data D2. The encoded data D2 is decoded into image data by the terminal device 73 via the Internet 71 and displayed. Accordingly, in the monitoring system 70, for example, when the terminal device 73 is a cellular phone, since the terminal device 73 is connected to the Internet 71 using a cellular phone line, a bandwidth of a transmission channel is extremely reduced. When the monitoring device 72 sends the encoded data D2 to the Internet 71 using a cellular phone line, the bandwidth of the transmission channel is also extremely reduced. In contrast, when connection to the Internet 71 is performed using a LAN, such as an optical fiber line, a sufficient bandwidth can be ensured for the transmission channel. As described above, the bandwidth of a transmission channel used for transmission of image data changes in a wide range.

Thus, in the monitoring system 70, the monitoring device 72 acquires an image pickup result via the image pickup element 75 at a frame rate corresponding to the bandwidth of the transmission channel, and image data D1 based on the image pickup result is encoded by the image processing circuit 78. In this encoding processing (see FIG. 1), the resolution of the image data D1 is sequentially and gradually reduced, and the number of stages for the gradual processing is changed in accordance with the bandwidth of the transmission channel and the image data D1. In addition, for image data D3 with the lowest resolution, encoded data D2 is generated by encoding the image data D3. For image data other than the image data D3, encoded data D2 is generated by encoding differential data D4 with respect to prediction image data generated from image data with a resolution lower by one stage.

Accordingly, in the monitoring system 70, when the bandwidth of the transmission channel is narrow and when the image data D1 is encoded with great difficulty, image data can be transmitted in many stages. Thus, in such a case, image data can be reliably transmitted with high image quality. In contrast, when the bandwidth of the transmission channel is wide enough and when the image data D1 is encoded with less difficulty, processing can be simplified by transmitting the image data in the smaller number of stages. Accordingly, the number of stages for reducing resolution can be changed in accordance with a bandwidth usable for transmission. Thus, even if the bandwidth of a transmission channel changes in a wide range, the change in the bandwidth can be properly dealt with.

In addition, in the first embodiment, such a reduction in resolution is performed by repeating processing of sequentially reducing the size of an image to half in the horizontal and vertical directions. Accordingly, by applying such simplified processing to processing of image pickup results of various resolutions, a reduced image can be reliably generated and image data can be encoded.

In addition, in such processing for the encoded data D2, after image data is rearranged by the image memory 93 in the order opposite to the order in which the resolution is gradually reduced, the subtractor circuit 94 generates differential data D4 with respect to prediction image data and the image encoding circuit 95 performs encoding. Thus, in generation of prediction image data in the monitoring device 72 and decoding in the monitor 83, encoded data D2 is sequentially processed and image data with a higher resolution can be sequentially decoded. Thus, the entire structure and processing can be simplified.

In addition, in generation of prediction image data, encoding is performed in accordance with the above-described order. From among image data D3 and differential data D4 acquired by processing encoded data D2, the image data D3 is temporarily stored in the image memory 99 and sequentially updated using image data that is obtained by adding differential data and prediction image data and that is output from the adding circuit 98. The enlarged image creation circuit 100 increases the resolution of the image data stored in the image memory 99 by one stage to generate the prediction image data. Accordingly, image data of a reduced image is sequentially encoded using the prediction image data obtained by predicting the image data reproduced by the decoding side. As described above, since, in encoding of differential data using such prediction image data, gradual encoding is performed using the previous encoded result, for example, unnecessary data transmission can be prevented by canceling the processing at a stage corresponding to the resolution of the monitor 83 provided in the terminal device 73. Thus, operations can be performed flexibly and efficiently in accordance with the system structure.

In addition, lossless encoding and lossy encoding can be set depending on the stage. Thus, image data can be transmitted with a desired image quality and a desired efficiency. Therefore, operations can be performed flexibly and efficiently in accordance with the system structure.

Thus, as described above, in the terminal device 73, the encoded data D2 output from the monitoring device 72 is decoded by processing equal to the series of processing relating to generation of a prediction image in an encoding unit and displayed by the monitor 83.

With this structure, a plurality of reduced images is generated by sequentially and gradually reducing resolution. For a reduced image with the lowest resolution, image data is encoded and output. For the other reduced images and the original image, differential data with respect to prediction image data based on a reduced image in the immediately previous stage is encoded and output. Accordingly, by changing the number of stages in accordance with the bandwidth usable for transmission, even if the bandwidth of a transmission channel changes in a wide range, the change in the bandwidth can be properly dealt with.

In addition, by changing the number of stages in accordance with an image pickup result obtained by an image pickup unit, even if the resolution of the image pickup result changes, image data can be transmitted with a high image quality while properly dealing with the change.

In addition, such a reduction in resolution is performed by repeating processing of sequentially reducing the size of an image to half in the horizontal and vertical directions. Thus, the resolution of image data can be sequentially reduced with a simplified structure.

In addition, after rearranging the order of image data acquired by reduction processing and sending encoded data based on a reduced image with the lowest resolution, encoded data based on differential data is sent in the order opposite to the order in which the resolution is gradually reduced. Thus, in generation of prediction image data and decoding in a transmitted side, corresponding processing can be performed with a simple structure only to process sequentially acquired encoded data. Thus, the entire structure can be simplified. In addition, since unnecessary data transmission can be prevented by canceling processing at a stage corresponding to the resolution of the monitor 83 provided in the terminal device 73, operations can be performed flexibly and efficiently in accordance with the system structure.

In addition, image data can be transmitted while prioritizing image quality by performing lossless encoding as encoding for such image data and differential data. In addition, image data can be transmitted while prioritizing transmission efficiency by performing lossy encoding. In addition, by selectively performing lossless encoding and lossy encoding in accordance with the stage of a reduced image, image data can be transmitted with a desired image quality and a desired efficiency. Thus, operations can be performed flexibly and efficiently in accordance with the system structure.

### Second Embodiment

Although a case where the number of stages is set by determining the bandwidth of a transmission channel in accordance with a line used for connection to the Internet is described in the first embodiment, the present invention is not limited to this. The number of stages may be set by determining a bandwidth in accordance with an answer given in response to data transmission to a device. In this case, in data transmission for determining a bandwidth, for example, a required time may be determined by tentatively transmitting an image pickup result. In addition, although a case where the present invention is applied to a monitoring system is described in the first embodiment, the present invention is not limited to this. The present invention is widely applicable to various image pickup devices for acquiring and transmitting image pickup results and to various decoding devices for decoding the image pickup results.

It should be understood by those skilled in the art that various modifications, combinations, sub-combinations and alterations may occur depending on design requirements and other factors insofar as they are within the scope of the appended claims or the equivalents thereof.

What is claimed is:

1. An image pickup device comprising:
an image pickup unit outputting an image pickup result;
an analog-to-digital converter analog-to-digital converting the image pickup result and outputting image data;
a reduced image generator generating a plurality of reduced images by sequentially and gradually reducing a resolution of an original image based on the image data a number of times equal to a predetermined number of stages;
an encoder in which, for a reduced image with the lowest resolution from among the plurality of reduced images generated by the reduced image generator, corresponding image data is encoded and encoded data is output, and for the other reduced images and the original image, differential data with respect to prediction image data based on the reduced image with a resolution lower by one stage is encoded and encoded data is output; and
a prediction image data generator generating the prediction image data from the encoded data.

2. The image pickup device according to claim 1, further comprising a controller changing the number of stages in the reduced image generator in accordance with the image pickup result output by the image pickup unit.

3. The image pickup device according to claim 1, further comprising a controller changing the number of stages in the reduced image generator in accordance with a bandwidth of a transmission channel for the encoded data.

4. The image pickup device according to claim 1, wherein the gradual reduction in the resolution in the reduced image generator is performed by repeating processing for sequentially reducing the size of an image to half in horizontal and vertical directions.

5. The image pickup device according to claim 1, wherein after the encoded data based on the reduced image with the lowest resolution is sent, the encoded data based on the differential data is sent in an order opposite to the order in which the resolution is gradually reduced in the reduced image generator.

6. The image pickup device according to claim 5, wherein the prediction image data generator includes:
a decoder decoding the encoded data to output the image data and the differential data;
an image memory temporarily storing the image data acquired by the decoder;
an enlarged image generator generating the prediction image data by increasing by one stage the resolution of an image based on the image data stored in the image memory; and
an adding circuit generating image data by adding the differential data decoded by the decoder to the prediction image data and updating the image data recorded in the image memory using the generated image data.

7. The image pickup device according to claim 1, wherein the encoding performed by the encoder for the reduced image with the lowest resolution or the encoding performed by the encoder for the differential data is lossless encoding.

8. The image pickup device according to claim 1, wherein the encoding performed by the encoder for the reduced image with the lowest resolution or the encoding performed by the encoder for the differential data is lossy encoding.

9. The image pickup device according to claim 1, wherein the encoder selectively performs lossless encoding and lossy encoding as the encoding in accordance with a stage of the reduced image.

10. The image pickup device according to claim 1, wherein the image pickup unit, the analog-to-digital converter, the reduced image generator, and the encoder are integrated into an integrated circuit.

11. A decoding device decoding image data encoded by a predetermined encoding device, wherein:
the encoding device includes a reduced image generator generating a plurality of reduced images by sequentially and gradually reducing a resolution of an original image based on the image data a number of times equal to a predetermined number of stages, an encoder in which, for a reduced image with the lowest resolution from among the plurality of reduced images generated by the reduced image generator, corresponding image data is encoded and encoded data is output, and for the other reduced images and the original image, differential data with respect to prediction image data based on the reduced image with a resolution lower by one stage is encoded and encoded data is output, and a prediction image data generator generating the prediction image data from the encoded data; and
the decoding device includes a decoder decoding the encoded data to output the image data and the differential data, an image memory temporarily storing the image data acquired by the decoder, an enlarged image generator generating the prediction image data by increasing by one stage the resolution of the image data stored in the image memory, and an adding circuit generating image data by adding the differential data decoded by the decoder to the prediction image data and updating the image data recorded in the image memory using the generated image data.

12. An encoding device comprising:
a reduced image generator generating a plurality of reduced images by sequentially and gradually reducing a resolution of an original image based on image data a number of times equal to a predetermined number of stages;
an encoder in which, for a reduced image with the lowest resolution from among the plurality of reduced images generated by the reduced image generator, corresponding image data is encoded and encoded data is output, and for the other reduced images and the original image, differential data with respect to prediction image data based on the reduced image with a resolution lower by one stage is encoded and encoded data is output; and
a prediction image data generator generating the prediction image data from the encoded data.

13. The encoding device according to claim 12, further comprising a controller changing the number of stages in the reduced image generator in accordance with a bandwidth of a transmission channel for the encoded data.

14. The encoding device according to claim 12, wherein the gradual reduction in the resolution in the reduced image generator is performed by repeating processing for sequentially reducing the size of an image to half in horizontal and vertical directions.

15. The encoding device according to claim 12, wherein after the encoded data based on the reduced image with the lowest resolution is sent, the encoded data based on the differential data is sent in an order opposite to the order in which the resolution is gradually reduced in the reduced image generator.

16. The encoding device according to claim 15, wherein the prediction image data generator includes:
a decoder decoding the encoded data to output the image data and the differential data;
an image memory temporarily storing the image data acquired by the decoder;
an enlarged image generator generating the prediction image data by increasing by one stage the resolution of an image based on the image data stored in the image memory; and
an adding circuit generating image data by adding the differential data decoded by the decoder to the prediction image data and updating the image data recorded in the image memory using the generated image data.

17. The encoding device according to claim 12, wherein the encoding performed by the encoder for the reduced image with the lowest resolution or the encoding performed by the encoder for the differential data is lossless encoding.

18. The encoding device according to claim 12, wherein the encoding performed by the encoder for the reduced image with the lowest resolution or the encoding performed by the encoder for the differential data is lossy encoding.

19. The encoding device according to claim 12, wherein the encoder selectively performs lossless encoding and lossy encoding as the encoding in accordance with a stage of the reduced image.
